(19) United States
(12) Patent Application Publication
(10) Pub. No.: US 2026/0233101 A1
(43) Pub. Date: Aug. 13, 2026

(54) INFORMATION PROCESSING DEVICE AND ACTIVITY GENERATING METHOD

(71) Applicant: SONY INTERACTIVE ENETERTAINMENT INC., Tokyo (JP)

(72) Inventor: Tatsuki Amimoto, Tokyo (JP)

(73) Assignee: SONY INTERACTIVE ENETERTAINMENT INC., Tokyo (JP)

(21) Appl. No.: 19/148,158

(22) PCT Filed: Feb. 27, 2023
(86) PCT No.: PCT/JP2023/006965

§ 371 Date: Jul. 15, 2025

(51) Int. Cl. A63F 13/63; A63F 13/533

(52) U.S. Cl. CPC A63F 13/63; A63F 13/533; A63F 2300/308

(57) ABSTRACT

A reception section 110 receives operation information regarding a game from a user, and a game execution section 112 executes the game according to the operation information regarding the game. During game play, when the reception section 110 receives an input of a start point from the user, a state value monitoring section 120 acquires state values in the game play. When the reception section 110 receives an input of an end point, a condition setting section 126 sets a play condition of an activity generated by a user, according to the state values acquired during a period from the start point to the end point of the game play.

### TECHNICAL FIELD

The present disclosure relates to a technique that allows a user to generate an activity serving as a play unit in a game.

### BACKGROUND ART

PTL 1 discloses a system which collects statuses of playing activities performed by a plurality of players and statistically processes lengths of playing time of the plurality of players for the activities. In the system disclosed in PTL 1, a play unit such as a quest or a mission is set as an activity, and a game device provides statuses of playing activities to a server device. The server device statistically processes the statuses of playing activities provided from a plurality of game devices, derives a length of playing time for each activity, and provides a user with information regarding the relevant length of playing time.

### CITATION LIST

### Patent Literature

[PTL 1] JP 2022-63754A

### SUMMARY

### Technical Problem

Conventionally, by imposing a self-restriction that is not set by a game developer, users increase the difficulty of the game, which playstyle has generally been called a “restricted playthrough.” The restricted playthrough is also called playing with restriction or a challenge run, and various types of restricted playthroughs such as a playstyle in which a user completes a game with low level maintained and a playstyle in which a user completes a game without using attacks or magic are devised by users.

While activities are defined as a play unit in order to help and advance game play of a user by a game developer, when users can freely generate their own activities and other users can play the generated activities, communication between the users is intensified, and in-game communities are expected to become activated. In view of this, building a system that allows a user to relatively easily generate an activity serving as a play unit in a game is demanded.

### Solution to Problem

An information processing device according to an aspect of the present disclosure includes one or more processors having hardware, in which the one or more processors receive operation information regarding a game from a user, execute the game according to the operation information regarding the game, receive an input of a start point of game play from the user, acquire state values in the game play, receive an input of an end point of the game play from the user, and set a play condition of an activity generated by the user, according to the state values acquired during a period from the start point to the end point of the game play. By setting a play condition of an activity, the activity is generated.

A method according to another aspect of the present disclosure is a method of generating an activity in an information processing device, the method including receiving operation information regarding a game from a user, executing the game according to the operation information regarding the game, receiving an input of a start point of game play from the user, acquiring state values in the game play, receive an input of an end point of the game play from the user, and setting a play condition of an activity according to the state values acquired during a period from the start point to the end point of the game play.

It is noted that any combinations of the constituent components described above and the expressions of the present disclosure that are converted between a method, an apparatus, a system, a recording medium, a computer program, and the like are also effective as aspects of the present disclosure.

### BRIEF DESCRIPTION OF DRAWINGS

FIG. 1 is a diagram illustrating a game system according to an embodiment.

FIG. 2 is a diagram illustrating a hardware configuration of an information processing device.

FIG. 3 is a diagram illustrating functional blocks of the information processing device.

FIG. 4 is a diagram illustrating an example of a game screen.

FIG. 5 is a flowchart indicating generation of a UG activity.

FIG. 6 is a diagram illustrating an example of a graphical user interface (GUI).

FIG. 7 is a diagram illustrating an example of the GUI.

FIG. 8 is a diagram illustrating an example of play contents performed during a period from a start point to an end point.

FIG. 9 is a diagram illustrating an example of state values at the start point.

FIG. 10 is a diagram illustrating an example of the state values acquired during the period from the start point to the end point.

FIG. 11 is a diagram illustrating an example of a condition setting screen.

FIG. 12 is a diagram illustrating an example of a play condition of an activity generated by a user.

FIG. 13 is a diagram illustrating an example of a notification region displayed.

FIG. 14 is a diagram illustrating an example of a ranking screen.

### DESCRIPTION OF EMBODIMENTS

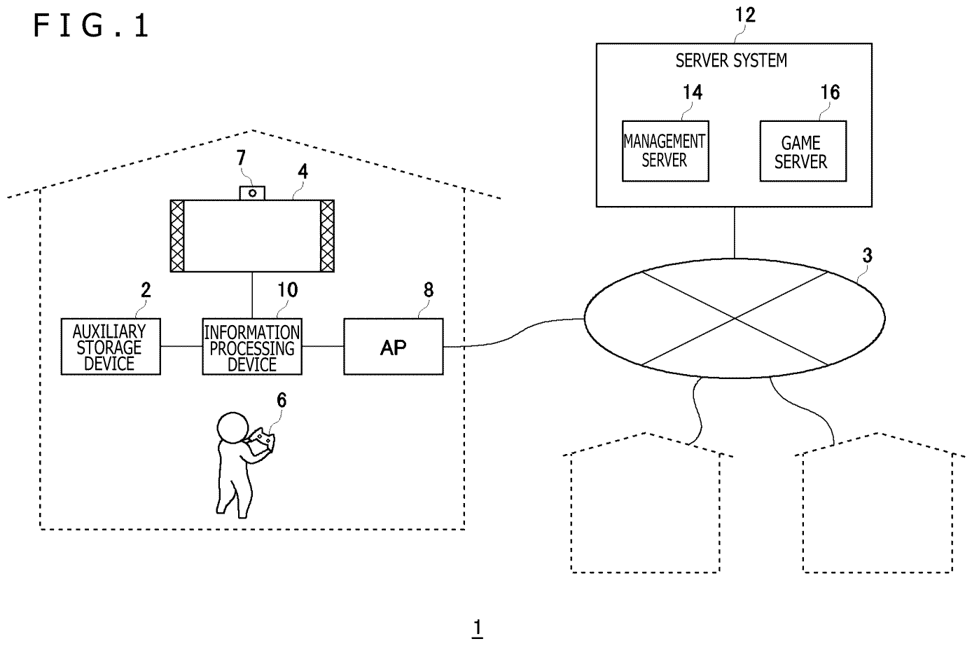

FIG. 1 illustrates a game system 1 according to an embodiment of the present disclosure. The game system 1 according to the embodiment includes an information processing device 10 operated by a user and a server system 12. The game system 1 provides an environment allowing a user to generate an activity serving as a play unit in a game by himself/herself.

An access point (hereinafter, called an “AP”) 8 has a function of a router and a wireless access point, and the information processing device 10 connects to the AP 8 in a wireless or wired manner to connect to the server system 12 on a network 3 such as the Internet through the AP 8 in such a manner as to be able to communicate with the server system 12. The server system 12 includes a management server 14 and a game server 16. Note that the management server 14 and the game server 16 may be provided as an integrated server device. FIG. 1 illustrates one user and one information processing device 10, and in the game system 1, a plurality of information processing devices 10 operated by a plurality of users are connected with the management server 14 and the game server 16 through the network 3.

The information processing device 10 connects to an input device 6 operated by a user, by wire or wirelessly. The input device 6 outputs, to the information processing device 10, information resulting from the user performing an operation. Upon accepting the operation information from the input device 6, the information processing device 10 reflects the operation information to processing by system software or game software and causes a result of processing to be output from an output device 4. In the game system 1, the information processing device 10 may be a game device (game console) that executes a game, and the input device 6 may be a device such as a game controller that supplies operation information from a user to the information processing device 10. Note that the input device 6 may be an input interface such as a keyboard or a mouse.

An auxiliary storage device 2 is a large-capacity storage device such as a hard disk drive (HDD) and a solid state drive (SSD) and may be a built-in storage device or may be an external storage device that connects to the information processing device 10 through a universal serial bus (USB) or the like. The output device 4 may be a television having a display that outputs an image and a speaker that outputs sound. The output device 4 may be connected with the information processing device 10 through a cable or may be connected wirelessly.

A camera 7 serving as an imaging device is provided in the vicinity of the output device 4, and captures an image of a space around the output device 4. FIG. 1 illustrates an example in which the camera 7 is attached to an upper portion of the output device 4, but the camera 7 may be disposed on a side portion or a lower portion of the output device 4. In any case, the camera 7 is disposed at a position that enables capturing of a user who is positioned in front of the output device 4. The camera 7 may be a stereo camera.

The management server 14 provides a network service to the user of the game system 1. The management server 14 manages a user account which identifies the user, and the user uses the user account to sign in to the network service provided by the management server 14. By signing in to the network service from the information processing device 10, the user can register, in the management server 14, save data regarding a game or a trophy that is a virtual prize obtained during game play. By being registered in the management server 14, the save data and the trophies can be synchronized between devices even in a case where the user uses an information processing device different from the information processing device 10.

The game server 16 manages communities of the game, or the like, and provides a service for the users to enjoy the game. The game system 1 according to the embodiment provides an environment that allows a user to generate an activity serving as a play unit by himself/herself, and the game server 16 shares the activity generated by the user with other users according to the need of the relevant user. Sharing such a self-generated activity of a user allows a plurality of users to enjoy the relevant activity.

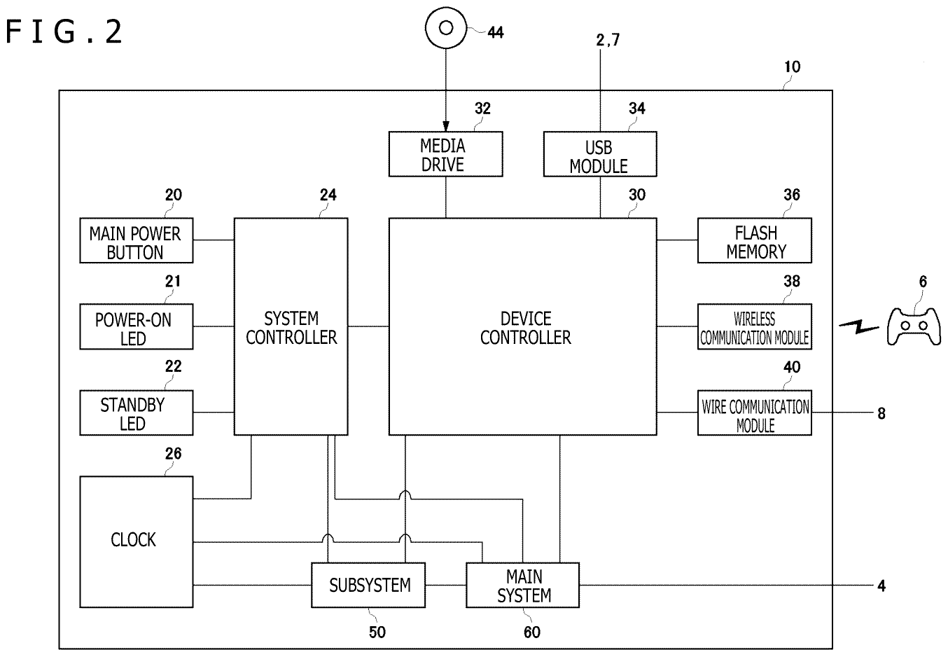

FIG. 2 illustrates a hardware configuration of the information processing device 10. The information processing device 10 includes a main power button 20, a power-ON light emitting diode (LED) 21, a standby LED 22, a system controller 24, a clock 26, a device controller 30, a media drive 32, a USB module 34, a flash memory 36, a wireless communication module 38, a wired communication module 40, a subsystem 50, and a main system 60.

The main system 60 includes a main central processing unit (CPU), a memory which is a main storage device, a memory controller, a graphics processing unit (GPU), etc. The GPU is mainly used in arithmetic processing for a game program. The main CPU has functionality for starting system software and executing, in an environment provided by the system software, a game program installed in the auxiliary storage device 2. The subsystem 50 includes a sub CPU, a memory that is a main storage device, a memory controller, etc., and is not provided with a GPU.

While the main CPU has a function of executing the game programs installed in the auxiliary storage device 2, the sub CPU has no such function. However, the sub CPU has a function of accessing the auxiliary storage device 2 and a function of exchanging data with the server system 12. The sub CPU has only such limited processing functions, and can thus operate with small power consumption compared to the main CPU. These functions of the sub CPU are executed when the main CPU is in a standby state.

The main power button 20 is an input unit used by a user to perform an input operation. The main power button 20 is provided on a front surface of a housing of the information processing device 10 and is operated to turn on or off power supply to the main system 60 of the information processing device 10. The power-ON LED 21 is lit when the main power button 20 is turned on, while the standby LED 22 is lit when the main power button 20 is turned off. The system controller 24 detects pressing down of the main power button 20 by the user.

The clock 26 is a real time clock and generates current date and time information. The clock 26 supplies the information to the system controller 24, the subsystem 50, and the main system 60.

The device controller 30 is configured as a large-scale integrated circuit (LSI) that executes information exchange between devices as a south bridge. As illustrated in FIG. 2, connected to the device controller 30 are such devices as the system controller 24, the media drive 32, the USB module 34, the flash memory 36, the wireless communication module 38, the wired communication module 40, the subsystem 50, and the main system 60. The device controller 30 absorbs the difference in electric property and data transfer speed among the devices and controls the timing of data transfer.

The media drive 32 is a drive device that is driven with a read only memory (ROM) medium 44 mounted thereto, the ROM medium 44 recording application software such as a game and license information, and reads out programs, data, and the like, from the ROM medium 44. The ROM medium 44 is a read only recording medium as exemplified by an optical disk, a magneto-optical disk, a Blu-ray disk, and the like.

The USB module 34 is a module connected to an external device by a USB cable. The USB module 34 may be connected to the auxiliary storage device 2 and the camera 7 by a USB cable. The flash memory 36 is an auxiliary storage device that configures an internal storage. The wireless communication module 38 is a communication protocol such as a Bluetooth (registered trademark) protocol and an Institute of Electrical and Electronics Engineers (IEEE) 802.11 protocol and wirelessly communicates with the input device 6. The wired communication module 40 performs wired communication with an external device and connects to the network 3 via the AP 8.

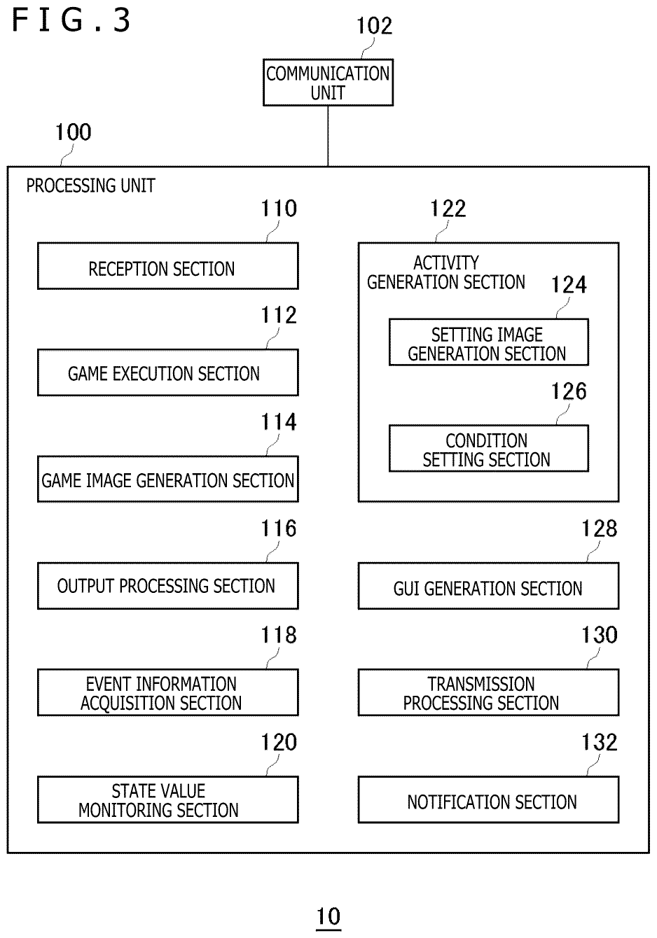

FIG. 3 illustrates functional blocks of the information processing device 10. The information processing device 10 includes a processing unit 100 and a communication unit 102, and executes game software that is installed in the auxiliary storage device 2. The processing unit 100 includes a reception section 110, a game execution section 112, a game image generation section 114, an output processing section 116, an event information acquisition section 118, a state value monitoring section 120, an activity generation section 122, a GUI generation section 128, a transmission processing section 130, and a notification section 132. The activity generation section 122 has a setting image generation section 124 and a condition setting section 126.

The information processing device 10 includes a computer, and various functions illustrated in FIG. 3 are implemented when the computer executes programs. The computer includes, as hardware, a memory to which programs are to be loaded, one or more processors that execute the programs loaded, an auxiliary storage device, other LSIs, and the like. The processor includes a plurality of electronic circuits including semiconductor integrated circuits and LSIs. The plurality of electronic circuits may be mounted onto one chip or may be mounted onto a plurality of chips. The functional blocks illustrated in FIG. 3 are implemented by cooperation between hardware and software. Accordingly, it should be understood by those skilled in the art that these functional blocks can be implemented in various forms including hardware only, software only, or a combination of the two.

The communication unit 102 receives information (operation information) input by the user for game play with the input device 6 and provides it to the reception section 110. When receiving the operation information regarding the game from the user, the reception section 110 provides it to the game execution section 112. Also, the communication unit 102 communicates with the management server 14 and/or the game server 16 to transmit and receive various pieces of information or data. The communication unit 102 may have functions of both the wireless communication module 38 and the wired communication module 40.

The game execution section 112 executes game software according to the operation information of the user. The game software includes at least a game program, image data, and sound data. While the user is playing a game, the reception section 110 receives the operation information of the user, and the game execution section 112 executes arithmetic processing to move a player character in a virtual space on the basis of the operation information of the user. The game image generation section 114 includes a GPU, and receives a result of the arithmetic processing in the virtual space to generate a game image from a viewpoint position (virtual camera) in the virtual space. Moreover, a game sound generation section (not illustrated) generates a game sound at the viewpoint position in the virtual space. The output processing section 116 outputs a game image and a game sound from the output device 4.

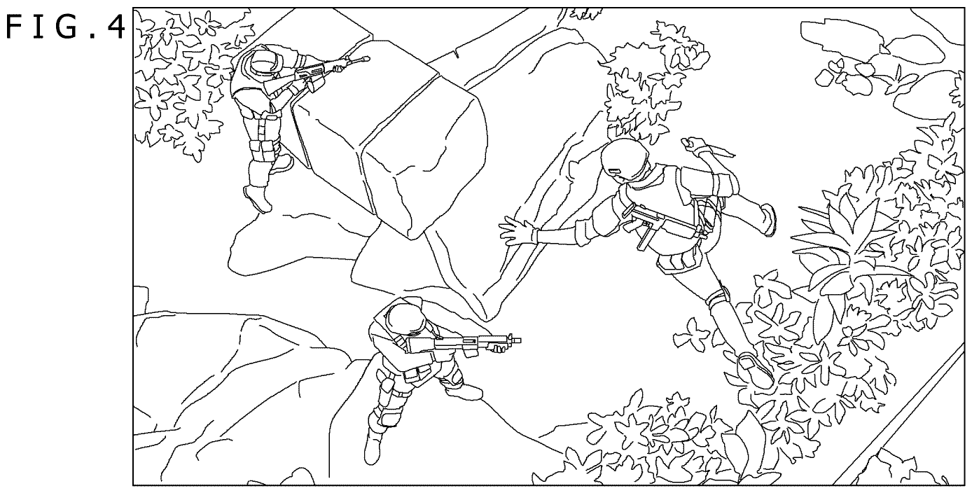

FIG. 4 illustrates an example of a game image displayed on the output device 4.

When an event occurs in the game, the game program of the embodiment outputs event information (event ID) identifying an event which has occurred. The event information acquisition section 118 acquires the event information and provides the acquired event information to the game server 16, so that the game server 16 can analyze a status of game play by a user. Hence, it is preferred that various events be coded into the game program.

The game includes a plurality of activities to which a start condition and an end condition are set. The end condition may be an accomplishment condition of an activity. An activity is one play unit that is incorporated in the game and that includes a stage, a quest, a sub-quest, a mission, a tournament, a session, or the like, and a play condition to be accomplished on the basis of operation by the user is set to each activity. In the embodiment, a series of game progresses from a point in time at which the start condition of the activity is fulfilled to a point in time at which the end condition of the activity is fulfilled constitutes one activity. For example, the start condition is set to occur when a player enters a castle of an enemy boss, and the end condition is set to occur when a player defeats the enemy boss. Activities are set by a game developer as needed, and one quest appearing in the progress of the game may constitute one activity, or a plurality of quests may constitute one activity. In a case in which a plurality of quests constitutes one activity, the end condition of the activity may be set to fulfil all conditions of accomplishing the plurality of quests.

When a certain activity is started, the game program outputs event information including information (event ID) identifying a start event of the relevant activity to the event information acquisition section 118. In addition, when a certain activity is ended, the game program outputs event information including information (event ID) identifying an end event of the relevant activity to the event information acquisition section 118. The event information may include not only the event ID, but also information (activity ID) identifying an activity, and may include information indicating a result of performing an activity (for example, success or failure). The event ID is set so as to be different from each activity.

It should be noted that not only an activity but also an event may be set according to occurrences and situational changes in the game. For example, an event may be set to an action that a character (player character) operated by a player equips a weapon, uses a healing item, and upgrades armor. In addition, an event may also be set when the player character levels up or the player character gets damaged. In this manner, the game developer can set an event to various occurrences and situational changes in the game. The game program outputs, when an event occurs during the game progress, event information including information (event ID) for identifying the corresponding event to the event information acquisition section 118.

When acquiring the event information, the event information acquisition section 118 generates event data by adding, to the acquired event information, the user identifier (user account) identifying the user, the game identifier (game ID) identifying the game, and the time information (time stamp) indicating the time of occurrence of the event, and then provides the generated event data to the transmission processing section 130. The game program may output the event information including the game ID and/or the time stamp to the event information acquisition section 118. The transmission processing section 130 transmits the event data provided from the event information acquisition section 118, through the communication unit 102 to the game server 16 in real time.

In the embodiment, the event information acquisition section 118 may provide event data to the state value monitoring section 120. The state value monitoring section 120 monitors state values with which a state of the game play is represented, according to the event data. By acquiring the state values in the game play, the state value monitoring section 120 may monitor the change in game state such as the level of the player character, an equipped item, and an activity having been cleared.

It should be noted that the state value monitoring section 120 is provided with the state values in the game play from the game server 16 and may acquire the state values of the game. As described above, the transmission processing section 130 transmits event data in real time to the game server 16, and the game server 16 acquires the state values in the game play in real time. The game server 16 transmits the acquired state values in the game play to the information processing device 10 in real time, and the state value monitoring section 120 then can acquire and monitor the state values in the game play in real time.

In the embodiment, the state value monitoring section 120 acquires the following state values according to, for example, the event data, and can monitor changes in the state values.
a level value of a player character
an equipped item
a used item
an activity that has been played
playing time

In the embodiment, the activity defining the state values of the game as a play condition can be generated freely by the user. In the following, in order to distinguish between the activities set in the game program and the activity generated by the user, the activity generated by the user may also be referred to as a “UG (User Generated) activity” in some cases.

The condition setting section 126 sets a play condition of a UG activity on the basis of the state values in the game obtained when the user has actually played the game. By setting the play condition on the basis of the state values during the user's actual play, the condition setting section 126 cannot set an unplayable play condition. For example, the condition setting section 126 cannot set a play condition that is unrealizable, for example, a play condition of completing the UG activity within one second.

In a case in which the user generates a series of stories in which a plurality of quests are sequentially played as a UG activity by himself/herself, a play condition is set on the basis of the state values obtained when the user actually plays the plurality of quests sequentially. In a case in which the user generates a UG activity designed with a completion at a low level (a playstyle in which the user completes the game while maintaining the low level), the user plays the plurality of quests while avoiding unintended level increases, and sets a play condition based on the state values obtained during the play. In addition, in a case in which the user generates a UG activity designed with a speedrun (a playstyle aiming to complete the game in the shortest possible time), the user plays the plurality of quests as fast as possible, and then sets a play condition on the basis of the state values obtained during the play.

In this manner, the user can set a play condition of the UG activity representing his/her play style. When the game server 16 shares the UG activity generated by the user to other users, the UG activity is allowed that the other users can challenge the relevant activity. Achieving such environment makes it possible to activate communication between users and enhance the activation of the in-game community.

### System in Which UG Activity is Generated

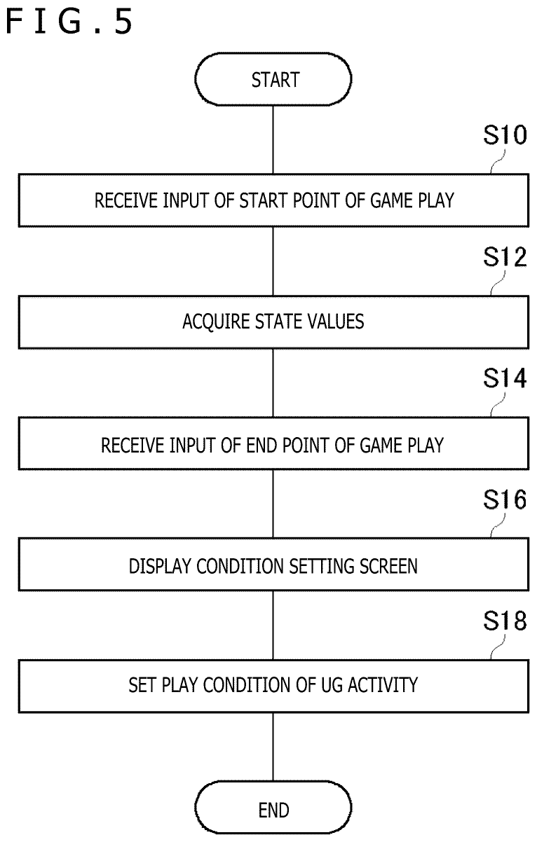

In the following, a system which allows the user to generate a UG activity will be described.
FIG. 5 indicates a flow chart of generation of a UG activity. The user generates a UG activity during game play.

The user operates a predetermined button (for example, a creation button) of the input device 6 during game play, and displays a GUI for generating a UG activity on the output device 4. When the reception section 110 receives an operation of the predetermined button, the GUI generation section 128 generates a GUI, and the output processing section 116 displays the GUI on a game screen in an overlapping manner.

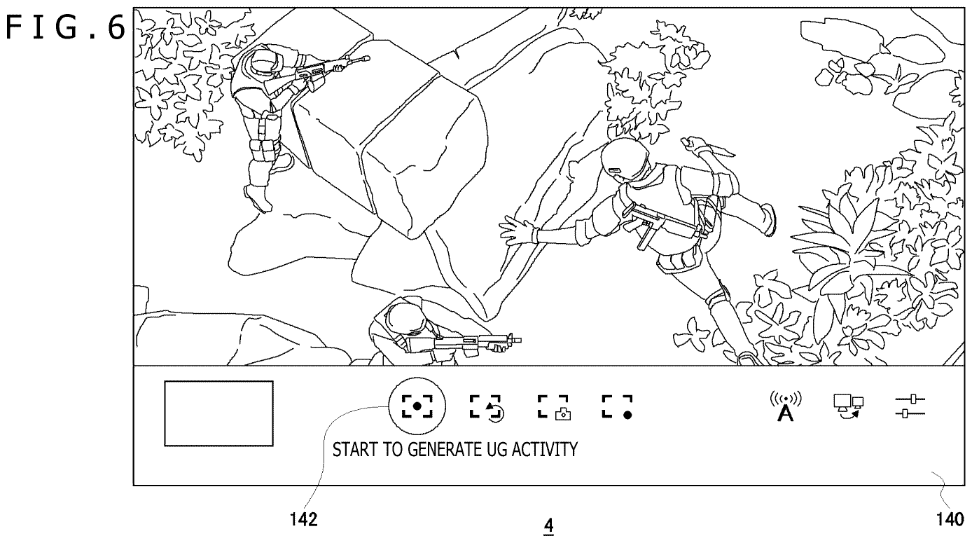

FIG. 6 indicates a GUI 140 displayed on the game screen in an overlapping manner. The GUI 140 includes a plurality of menu items. The user operates the input device 6 and moves a selection frame 142 to a position of a desired menu item, thereby selecting the relevant menu item. In an example illustrated in FIG. 6, the selection frame 142 is placed on a menu item “START TO GENERATE UG ACTIVITY.” When the user operates a confirm button of the input device 6 in this state, the reception section 110 receives an input of a start point of game play for generating a UG activity (S10).

When the start point of the game play is input, the state value monitoring section 120 acquires the state values of the game at the start point and starts to monitor the state values (S12). As described above, the state values may include a level value of a player character, an equipped item, a used item, an activity having been played, and a playing time.

The user performs the game play corresponding to the play style devised by himself/herself. The user performs a restricted playthrough, So that the user may generate a UG activity that attracts the interest of other users. When ending the gameplay for generating the UG activity, the user operates a predetermined button (for example, the creation button) of the input device 6, and displays a GUI for ending the generation of the UG activity on the output device 4.

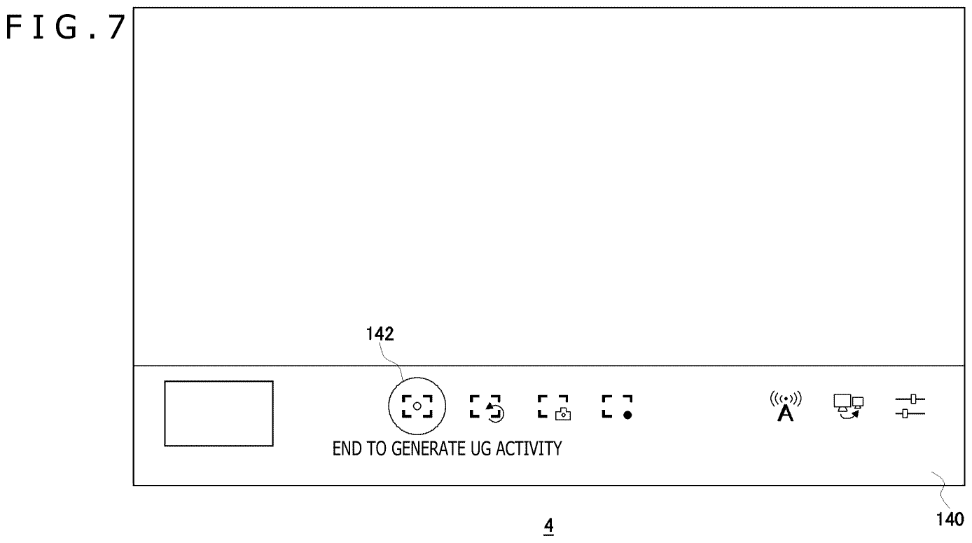

FIG. 7 illustrates an example of the GUI 140 that is displayed on the game screen in an overlapping manner. In FIG. 7, illustration of the game screen is omitted. When the user places the selection frame 142 on the menu item “END TO GENERATE UG ACTIVITY” and operates the confirm button of the input device 6, the reception section 110 receives an input of the end point of the game play for generating the UG activity (S14). The state value monitoring section 120 acquires the state values related to generation of the activity during a period from the start point to the end point of the game play.

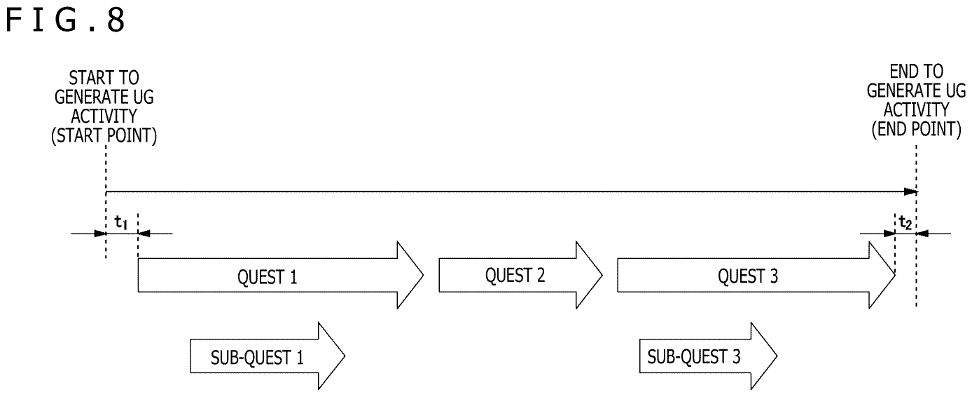

FIG. 8 illustrates an example of play contents performed during the period from the start point to the end point specified by the user. The user performs QUEST 1, QUEST 2, and QUEST 3 from the start point to the end point of the game play for generation of the activity, and performs SUB-QUEST 1 during play of QUEST 1 and performs SUB-QUEST 3 during play of QUEST 3. During this period, the game program outputs start event information and end event information of each quest as well as start event information and end event information of each sub-quest to the event information acquisition section 118. In addition, when the level or the equipment of the player character changes or an item is used, the game program outputs event information associated with the relevant event to the event information acquisition section 118.

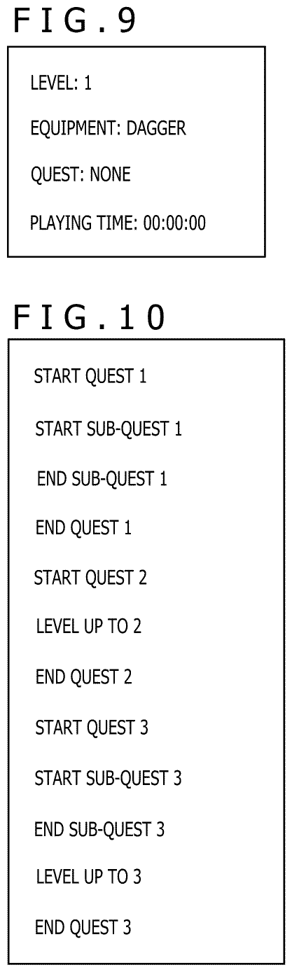

FIG. 9 indicates an example of the state values at the start point. When the start point of the game play is input by the user, the state value monitoring section 120 acquires the state values at the start point. The state value monitoring section 120 may acquire the state values at the start point from event data prior to the start point. In this example, state values that the level of the play character is 1, the equipment is a dagger, and no quest is currently played are acquired. The state value monitoring section 120 sets a playing time at the start point to 00:00:00 in order to measure a playing time of the UG activity.

FIG. 10 indicates an example of the state values acquired during the period from the start point specified by the user to the end point. The state value monitoring section 120 acquires the state values related to the play condition of the UG activity, during the period from the start point to the end point (hereinafter, also simply referred to as a “play period”), according to event data. In this example, the state values indicating the start and the end of each quest and each sub-quest and level change of the player character are acquired. In this play period, the player character levels up to 3. It should be noted that the equipment remains unchanged, and no item is used.

The condition setting section 126 sets a play condition of the activity generated by the user, on the basis of the state values acquired during the period from the start point to the end point of the game play (play period). The condition setting section 126 may set a play condition of the activity generated by the user, on the basis of changes of the state values acquired during the play period. While the condition setting section 126 may automatically set the play condition from the state values acquired, the user may be allowed to adjust a play condition temporarily set by the condition setting section 126.

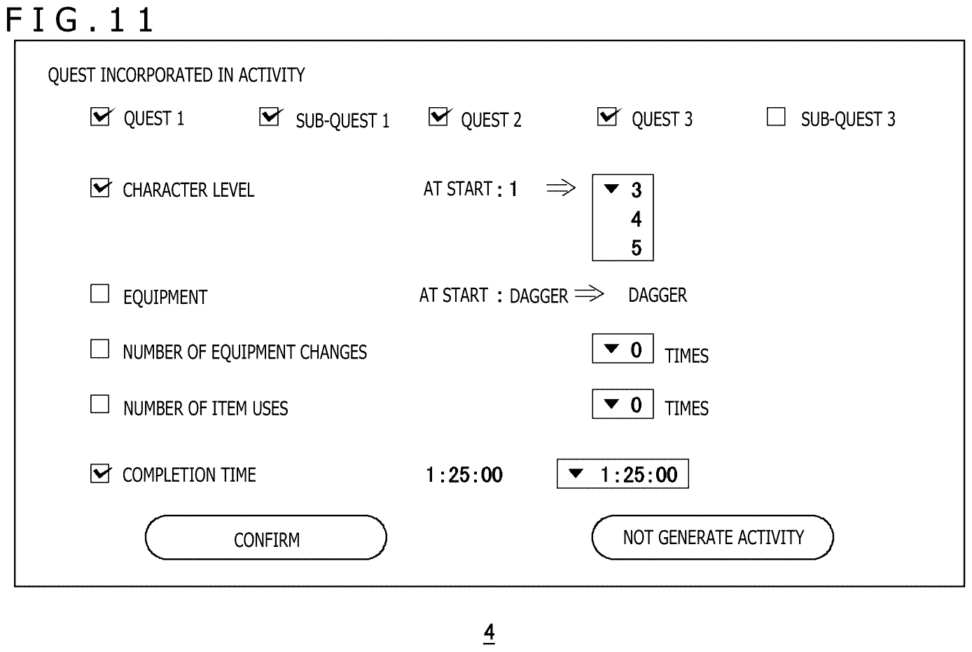

FIG. 11 illustrates an example of a condition setting screen to be displayed on the output device 4. When the reception section 110 receives an input of the end point of the game play, the setting image generation section 124 generates a condition setting screen for the user to adjust the play condition, on the basis of the state values acquired during the play period, and the output processing section 116 displays the generated condition setting screen on the output device 4 (S16).

The output processing section 116 displays a condition setting screen indicating the changes of the state values during the play period. The user selects menu items included in the condition setting screen, so that the selected menu items can be included in the play condition. This means that, if the user does not select remaining menu items included in the condition setting screen, the user can eliminate unselected menu items from the play condition. In FIG. 11, the menu items selected by the user are checked. The condition setting screen includes a GUI for the user to change the play condition determined according to the changes of the state values during the play period.

In the example of FIG. 11, a plurality of quests (QUEST 1, QUEST 2, and QUEST 3) and sub-quests (SUB-QUEST 1 and SUB-QUEST 3) performed by the user during the play period are displayed. The setting image generation section 124 generates a condition setting image on the basis of the play contents performed by the user during the play period, and accordingly, quests and/or sub-quests not performed by the user during the play period are not included in the condition setting screen. By ticking a check mark in a checkbox, the user can select quest and/or sub-quests to be incorporated in the activity. In this example, QUEST 1, SUB-QUEST 1, QUEST 2, and QUEST 3 are selected, while SUB-QUEST 3 is not selected. Hence, the play condition of the UG activity does not include performing SUB-QUEST 3.

On the condition setting screen, the character level indicates that the character level increases from 1 at the start point to 3. That is, during the play period, the user operates a player character with a low level and completes a plurality of quests and sub-quests. The user selects the menu item of the character level, thereby allowing the character level to be included in the play condition.

As illustrated in the figure, the GUIs included in the condition setting screen make it possible to change the play condition determined according to the changes of the state values during the play period to a direction of easing the corresponding play condition (direction of allowing completion (accomplishment) of the UG activity to be easily made). In this example, the level of the player character determined by play of the user is 3. However, the GUI is configured such that the upper limit of the character level can be set from 3 to 5. When the user thinks that it is difficult (or it is not possible) for other users to complete the relevant UG activity with the same player character level as that of the user, the user may set the condition of the character level to be easier, allowing many users to enjoy this UG activity.

It should be noted that GUI included in the condition setting screen may disallow changes to a direction of making the play condition determined according to the changes of the state values during the play period more strict (direction of making completion (accomplishment) of the UG activity more difficult). As such, the GUI prevents the upper limit of the character level from being set to 1 or 2. With this restriction, the user cannot set the play condition that has not been performed by himself/herself and can set the play condition according to the user's performance history only.

The condition setting screen indicates that equipment has not been changed. In a case in which the user sets the play condition allowing a player to be equipped with a dagger only, it is sufficient if the user selects a menu item of equipment. Since the menu item of equipment is not selected in this example, there is no restriction on equipment, and the play condition in which any types of equipment can be used is set.

Menu items such as “NUMBER OF EQUIPMENT CHANGES” and “NUMBER OF ITEM USES” determine the maximum number of changing equipment and the maximum number of using items, respectively. In this example, the menu items of “NUMBER OF EQUIPMENT CHANGES” and “NUMBER OF ITEM USES” are not selected, and accordingly, the play condition which has no restriction on the number of equipment changes and the number of item uses is set.

The menu item “COMPLETION TIME” indicates that a length of playing time from the start point to the end point was 1:25:00. The user can adjust this “COMPLETION TIME” in such a manner as to be easier, that is, to be longer than 1:25:00. As described above, the user cannot adjust this “COMPLETION TIME” in such a manner as to be shorter.

When the user operates “CONFIRM” button with use of the input device 6, the condition setting section 126 confirms and saves the play condition specified on the condition setting screen (S18). It should be noted that, in a case in which the user cannot satisfy his/her play contents, the user operates “NOT GENERATE ACTIVITY” button, and it is sufficient if the user may play the game again.

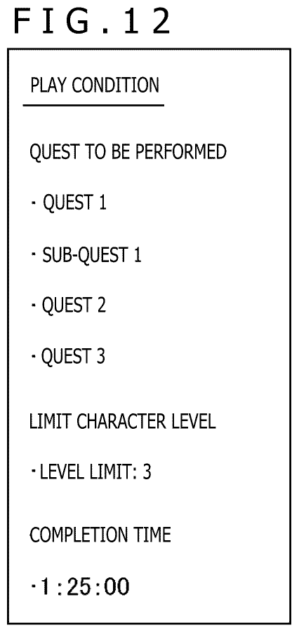

FIG. 12 indicates an example of a play condition for an activity generated by the user. In this example, the condition setting section 126 determines the upper limit of the character level as the play condition, and the maximum of the level increase may be determined as the play condition. During the play period, the player character increases by two from level 1 to level 3, and the condition setting section 126 can also determine that the maximum of the level increase in the UG activity is 2. The method of setting the condition in the condition setting section 126 may be determined for each game.

It should be noted that the condition setting section 126 may set the order of playing quests and sub-quests according to an instruction of the user as the play condition. For example, the condition setting section 126 may set to start the play in the order of QUEST 1, SUB-QUEST 1, QUEST 2, and QUEST 3, as the play condition.

In addition, with reference to FIG. 8, time t₁ has elapsed from the start point to the start time of QUEST 1, and the condition setting section 126 may eliminate this elapsed time t₁ from the completion time. Similarly, time t₂ has elapsed from the end of QUEST 3 to the end point, and the condition setting section 126 may eliminate this elapsed time to from the completion time. In this case, the user can set the completion time slightly shorter than 1:25:00.

In this manner described above, the user can generate his/her own UG activity. The user generates the name and description of the UG activity thus generated, and adds them as help information for the UG activity. The transmission processing section 130 transmits the play condition of the UG activity generated by the user and the name and description of the relevant activity to the game server 16. The game server 16 assigns an ID and a link to the UG activity and shares the UG activity to other users, and accordingly, the other users can play the relevant UG activity.

The user may be allowed to select a range in which to share the UG activity. For example, a sharing range may be limited to the user's friends only, or may be made widely available to friends of the user's friends. Alternatively, the sharing range may be limited to followers of the user only. It should be noted that, since the user generates the description of the UG activity, the user may limit the sharing range to users in a region where the same language as the user is used or users in the same country as the user. The sharing range may be set in combination of these, or the UG activity may be shared to all users without any limitations on the sharing range. Moreover, the user may set the start time and the end time of sharing the UG activity. In order to make many users play the UG activity, high scorers may be awarded points that can be used in the game as a prize, for example, which encourages greater motivation to play the UG activity.

### System of Playing UG Activity

Next, a system of playing the UG activity will be described.
When a user operates a predetermined operation, the notification section 132 transmits the request of acquisition of the UG activity to the game server 16. The game server 16 selects one or more UG activities suitable to the relevant user, according to predetermined criteria, and transmits information regarding the selected UG activity to the information processing device 10 of the relevant user.

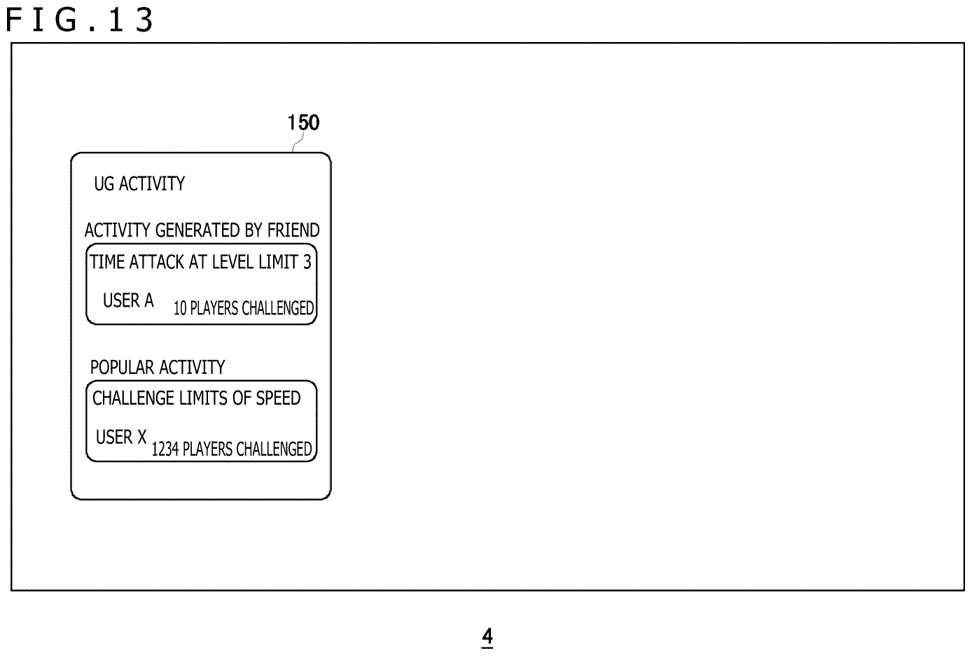

FIG. 13 illustrates an example of a notification region 150 displayed on the output device 4. When the user performs a predetermined operation during the game play, a notification section 136 acquires information regarding the UG activity from the game server 16 and provides it to the output processing section 116, and the output processing section 116 displays the notification region 150 including a list of the UG activity on a game image in an overlapping manner. It should be noted that the output processing section 116 may display the notification region 150 on the output device 4 not only during the game play. On the notification region 150 illustrated in FIG. 13, a plurality of UG activities that are available for the users to play are displayed. An activity “TIME ATTACK AT LEVEL LIMIT 3” generated by a user A who is a friend and an activity “CHALLENGE LIMITS OF SPEED” generated by a user X are displayed here. It should be noted that “TIME ATTACK AT LEVEL LIMIT 3” and “CHALLENGE LIMITS OF SPEED” are UG activities named by the respective users. In a case in which some users have already played the UG activity, the number of users having played may be displayed.

When receiving the acquisition request of the UG activity from the user, the game server 16 selects the UG activity according to the predetermined criteria. For example, the game server 16 may preferentially select an UG activity generated by a friend of the user or a UG activity generated by a user followed by the user. In addition, the game server 16 may select a highly popular UG activity or a UG activity that is difficult to complete.

It should be noted that the game server 16 does not select a UG activity that the user cannot play. For example, in a case in which the level of the player character is 10, since the user cannot play the UG activity requiring the level 3 as the upper limit, the game server 16 does not select the activity requiring the level 3 as the upper limit for the user. It should be noted that, even if the user cannot play a UG activity, as long as the UG activity is generated by a friend or a follower of the corresponding user, the game server 16 may exceptionally include it in the list of the UG activity.

It should be noted that, in the embodiment, only when playing the UG activity, the state values of the user for the game may be changed temporarily. For example, in a case in which the level is 10, in order to make the UG activity requiring the level 3 as the upper limit available, the state values may be controlled in such a manner as to temporarily decrease the level to 3 or smaller. It should be noted that such changes of the state values are limited to a time of playing the UG activity, and when play of the relevant UG activity is ended, the state values are restored to the original ones. In addition, saved data of the user who has generated the UG activity is stored in the game server 16, and with this saved data, the UG activity may be made available to play.

The game server 16 may compile the play results of the UG activity, and generate a ranking.

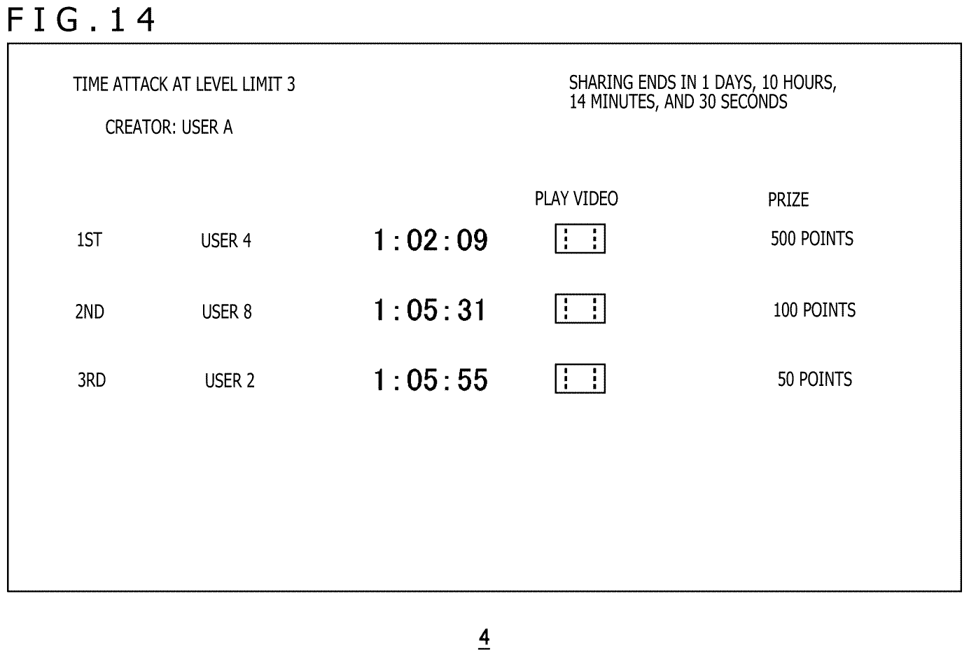

FIG. 14 illustrates an example of a ranking screen. The user preliminarily sets the criteria of the ranking, upon generation of the UG activity. In this example, the ranking criteria is set such that a user who completes the UG activity in the shortest time is ranked higher. For example, if the UG activity is intended for aiming at obtainment of a high score within a limited period of time, a ranking may be generated in a descending order of scores. In addition, the user who has generated the UG activity may be allowed to take part in ranking. On the ranking screen illustrated in FIG. 14, play videos are included. However, to avoid spoilers, sharing the play videos may be performed after the end of the sharing period of the UG activity.

The present disclosure has been described above on the basis of the embodiment thereof. The foregoing embodiment is illustrative, and it is to be understood by those skilled in the art that combinations of constituent components and processing processes of the embodiment are susceptible of various modifications and that such modifications also fall within the scope of the present disclosure. In the embodiment, the process in which the user generates an activity is performed by the information processing device 10, but the process may be performed by the game server 16. In this case, the game server 16 may include a function of the information processing device 10, and the game server 16 assists in generation of an activity by the user, as the information processing device.

The embodiment has explained that the state value monitoring section 120 acquires the state values in the game play according to the event data and monitors the changes of the state. In the modification, the state value monitoring section 120 may directly inquire with the game regarding the state values in the game play. In addition, when the game is configured such that, when the state values change, the changed state values are output to the state value monitoring section 120. In this manner, the state value monitoring section 120 may acquire the state values in the game play by any method, and it is sufficient if the changes of the state values may be grasped from the start point to the end point of the game play specified by the user.

### INDUSTRIAL APPLICABILITY

The present disclosure is applicable to a technique that allows a user to generate his/her own activity.

### REFERENCE SIGNS LIST

1: Game system
4: Output device
10: Information processing device
12: Server system
14: Management server
16: Game server
100: Processing unit
102: Communication unit
110: Reception section
112: Game execution section
114: Game image generation section
116: Output processing section
118: Event information acquisition section
120: State value monitoring section
122: Activity generation section
124: Setting image generation section
126: Condition setting section
128: GUI generation section
130: Transmission processing section
132: Notification section

1. An information processing device comprising:
one or more processors;
wherein the one or more processors:
receive operation information regarding a game from a user;
execute the game according to the operation information regarding the game;
receive an input of a start point of game play from the user;
acquire state values in the game play;
receive an input of an end point of the game play from the user; and
set a play condition of an activity generated by the user, according to the state values acquired during a period from the start point to the end point of the game play.

2. The information processing device according to claim 1, wherein the one or more processors:
set the play condition according to changes of the state values during the period from the start point to the end point.

3. The information processing device according to claim 1, wherein the one or more processors:
display a condition setting screen indicating changes of the state values during the period from the start point to the end point.

4. The information processing device according to claim 3, wherein the one or more processors:
display the condition setting screen including a graphical user interface for the user to change the play condition determined according to the changes of the state values during the period from the start point to the end point.

5. The information processing device according to claim 4, wherein the one or more processors:
allow the graphical user interface included in the condition setting screen to change the play condition determined according to the change of the state values during the period from the start point to the end point, in such a manner as to make the play condition easier.

6. A method comprising:
receiving operation information regarding a game from a user;
executing the game according to the operation information regarding the game;
receiving an input of a start point of game play from the user;
acquiring state values in the game play;
receive an input of an end point of the game play from the user; and
setting a play condition of an activity according to the state values acquired during a period from the start point to the end point of the game play.

7. non-transitory computer-readable medium storing computer-executable instructions which, when executed by a processor, cause a system to perform operations comprising:
receiving operation information regarding a game from a user;
executing the game according to the operation information regarding the game;
receiving an input of a start point of game play from the user;
acquiring state values in the game play;
receiving an input of an end point of the game play from the user; and
setting a play condition of an activity according to the state values acquired during a period from the start point to the end point of the game play.
